(19) United States
(12) Patent Application Publication
(10) Pub. No.: US 2026/0194094 A1
(43) Pub. Date: Jul. 9, 2026

(54) Connecting Rod Splicing Device

(71) Applicant: Ningbo East Cleaning Tool Co., Ltd., Ningbo City (CN)

(72) Inventors: Yong Yang, Ningbo City (CN); Ailiang Li, Ningbo City (CN); Ying Li, Ningbo City (CN)

(73) Assignee: Ningbo East Cleaning Tool Co., Ltd, Ningbo City, Zhejiang Province (CN)

(21) Appl. No.: 19/031,404

(22) Filed: Jan. 18, 2025

(30) Foreign Application Priority Data
Jan. 7, 2025 (CN) 202510023376.2

(51) Int. Cl. F16B 7/04

(52) U.S. Cl. CPC F16B 7/0426

(57) ABSTRACT

Disclosed is a connecting rod splicing device, including: a casing tube provided with a first positioning hole; an insertion tube provided with a reducing tube and a second positioning hole, where the reducing tube is inserted into one end of the casing tube, and the first positioning hole is communicated with the second positioning hole; a locking sleeve sleeved at one end of the casing tube and provided with a locking hole; a locking button rotatably arranged on the locking sleeve and provided with a button plate and a locking column; and an elastic rod configured to keep the locking column in an inserted state, where an elastic angle is formed between the elastic rod and the button plate, and the elastic angle enables that the locking column is pulled out of the first positioning hole and the second positioning hole when the locking button is pressed.

### TECHNICAL FIELD

The present disclosure relates to a splicing connecting rod, and in particular to a connecting rod splicing device.

### BACKGROUND

To achieve rod extension in a process of using a tool, two rods are usually spliced together, and after the two rods are spliced, a locking device is also needed to lock the two rods to prevent the two rods from separating. For example, the Chinese patent CN215457752U discloses a mop with a detachable mop rod. The mop includes a mop body, a mop rod and a quick connector, where the mop body is connected with the mop rod through the quick connector, the quick connector includes an elastic member and a pressing member, and a positioning protrusion on an inner wall of the elastic member is in positioning fit with the mop body and the mop rod; specifically, the elastic member is wrapped around an end portion of the mop body, the pressing member is eccentrically arranged at an opening of the elastic member, a bottom end of the mop rod is placed inside the mop body, the mop rod and the mop body are respectively provided with positioning holes, and the positioning protrusion is placed inside the corresponding positioning hole after assembly, to fix the mop rod and the mop body; and when the pressing member is pressed, the elastic member is deformed and then moved, such that the positioning protrusion is separated from the mop body and the mop rod, and the mop rod is detached from the mop body. Although the mop achieves splicing of two tubes, many components and complex structures thereof result in high costs and assembly complexity.

### SUMMARY

To solve the above problems of many components, high costs and assembly complexity, the present disclosure provides a connecting rod splicing device, with a specific technical solution as follows:
a connecting rod splicing device, including: a casing tube, where one end of the casing tube is provided with a first positioning hole; an insertion tube, where one end of the insertion tube is provided with a reducing tube and a second positioning hole on the reducing tube, the reducing tube is inserted into one end of the casing tube, and the first positioning hole is communicated with the second positioning hole; a locking sleeve, where the locking sleeve is sleeved at one end of the casing tube, and is provided with a locking hole arranged opposite to the first positioning hole; a locking button, where the locking button is rotatably arranged on the locking sleeve and provided with a button plate and a locking column that is arranged on the button plate and movably inserted into the locking hole, the first positioning hole and the second positioning hole; and an elastic rod configured to keep the locking column in an inserted state, where an elastic angle is formed between the elastic rod and the button plate, and the elastic angle enables that the locking column is pulled out of the first positioning hole and the second positioning hole when the locking button is pressed.

Preferably, a positioning ring is arranged at one end of the locking sleeve, and the positioning ring is configured to abut against an end portion of the casing tube to ensure that the locking hole is arranged opposite to the first positioning hole.

Further, a positioning block is arranged inside the locking sleeve, and the positioning block is arranged opposite to a positioning groove on the casing tube to ensure that the locking hole is communicated with the first positioning hole.

Guide arc corners are formed at both ends of the positioning groove.

Preferably, the reducing tube is provided with an insertion groove arranged opposite to the locking column.

Preferably, both the first positioning hole and the second positioning hole are waist-shaped holes.

Preferably, the locking sleeve is provided with a locking groove, rotating holes are formed on both sides of the locking groove, and the locking hole is formed at a bottom of the locking groove; and

rotating shafts are symmetrically arranged on both sides of the locking button, and the rotating shafts are rotatably arranged inside the rotating holes.

Preferably, a variable-diameter tube is further arranged between the reducing tube and the insertion tube, and the variable-diameter tube abuts against the locking sleeve to ensure that the second positioning hole is arranged opposite to the first positioning hole.

Preferably, the locking button is provided with an elastic pressure groove arranged opposite to the elastic rod.

Preferably, one end of the elastic rod that is in sliding contact with the locking sleeve is provided with a sliding arc surface.

Preferably, an end portion of the locking column is provided with an insertion arc surface.

Compared with the prior art, the present disclosure has the following beneficial effects:

The connecting rod splicing device provided by the present disclosure requires use of fewer parts, has a simple structure, lowers costs, and simplifies assembly, which can be used in a more convenient manner.

### BRIEF DESCRIPTION OF THE DRAWINGS

FIG. 1 is a structural schematic diagram of the present disclosure.

FIG. 2 is a structural schematic diagram of the present disclosure with a locking sleeve hidden.

FIG. 3 is a front view of the present disclosure.

FIG. 4 is a sectional view of the present disclosure.

FIG. 5 is a structural schematic diagram of a casing tube.

FIG. 6 is a structural schematic diagram of an insertion tube.

FIG. 7 is a schematic diagram of assembly of a locking sleeve and a locking button.

FIG. 8 is a sectional view of FIG. 7.

FIG. 9 is a space diagram of a first view of a locking button.

FIG. 10 is a space diagram of a second view of a locking button.

FIG. 11 is a bottom view of a locking button.

FIG. 12 is a front view of a locking button.

FIG. 13 is a sectional view of a locking button.

FIG. 14 is a structural schematic diagram of a locking sleeve.

FIG. 15 is a sectional view of a locking sleeve.

FIG. 16 is a top view of a locking sleeve.

FIG. 17 is a structural schematic diagram of a reducing tube with an insertion groove.

### DETAILED DESCRIPTIONS OF THE EMBODIMENTS

The present disclosure will be further described below with reference to the accompanying drawings.

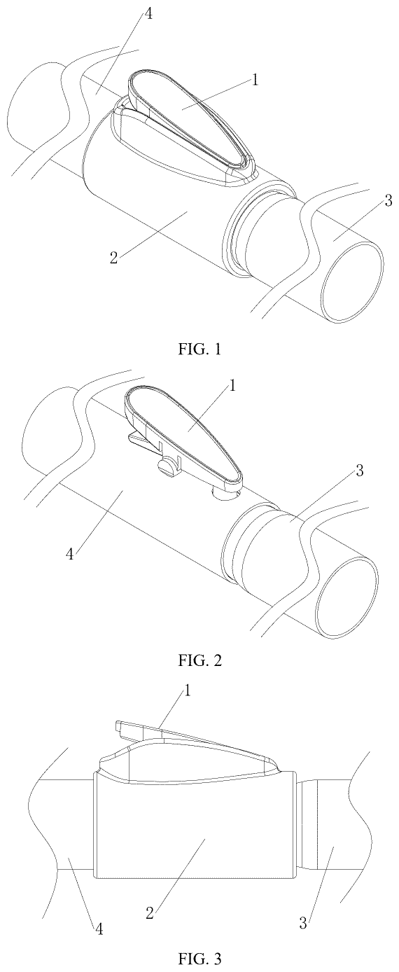

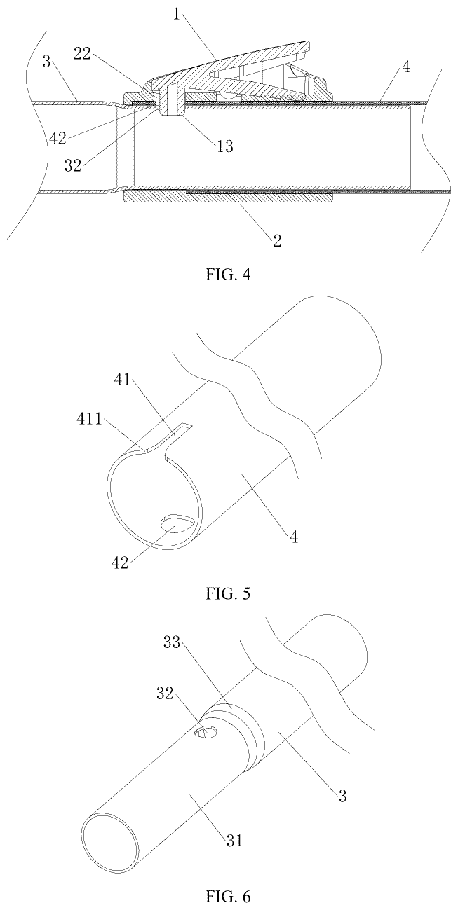

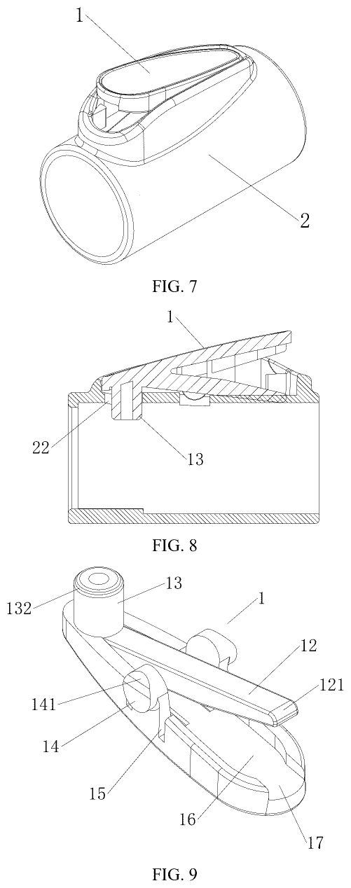

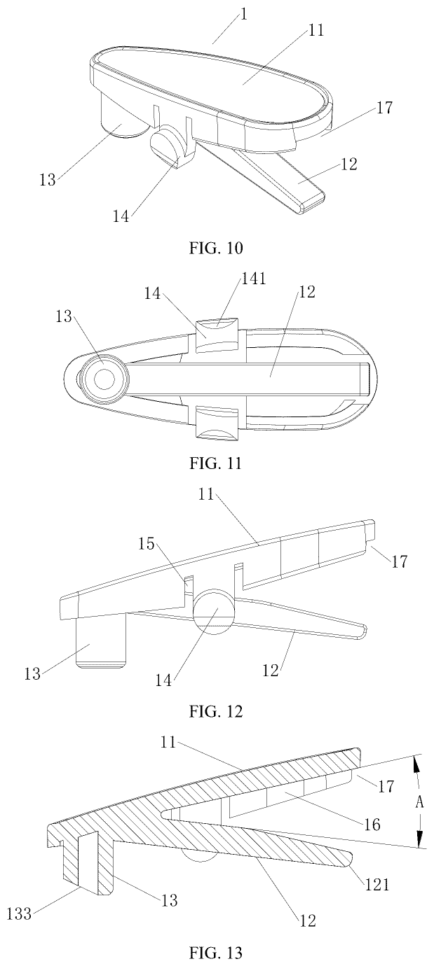

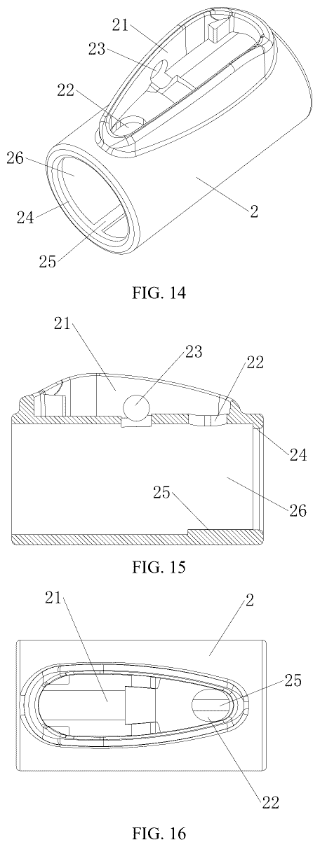

As illustrated in FIGS. 1-17, a connecting rod splicing device includes a casing tube 4, an insertion tube 3, a locking sleeve 2, and a locking button 1, where one end of the casing tube 4 is provided with a first positioning hole 42; one end of the insertion tube 3 is provided with a reducing tube 31 and a second positioning hole 32, where the second positioning hole 32 is formed on the reducing tube 31, the reducing tube 31 is inserted into one end of the casing tube 4, and the first positioning hole 42 is communicated with the second positioning hole 32; and the insertion tube 3 is inserted into the casing tube 4 to achieve rod extension and facilitate storage. The locking sleeve 2 is mounted at one end of the casing tube 4, and the locking sleeve 2 is provided with a locking hole 22 arranged opposite to the first positioning hole 42; the locking button 1 is rotatably mounted on the locking sleeve 2, and the locking button 1 is provided with a button plate 11, a locking column 13 and an elastic rod 12 arranged on the button plate 11, where the locking column 13 is movably inserted into the locking hole 22, the first positioning hole 42, and the second positioning hole 32, such that the insertion tube 3 is not separated from the casing tube 4; and the elastic rod 12 is configured to keep the locking column 13 in an inserted state, an elastic angle A is further formed between the elastic rod 12 and the button plate 11, and the elastic angle A enables that the locking column 13 is pulled out of the first positioning hole 42 and the second positioning hole 32 when the locking button 1 is pressed.

Only two parts are needed to achieve locking of connecting rod splicing, which greatly reduces use of parts, and facilitates assembly and use of the parts with simple structures.

The elastic rod 12 enhances elasticity, the elastic rod 12 keeps the locking column 13 in the inserted state, and when the button plate 11 is pressed and a force applied to the button plate 11 is greater than an elastic force provided by the elastic rod 12, the button plate 11 rotates around an axis of the rotating shaft 14, and one end of the button plate 11 with the locking column 13 rotates upward, such that the locking column 13 is separated from the first positioning hole 42 and the second positioning hole 32 on the casing tube 4 and the insertion tube 3 respectively, so as to achieve disassembly of the casing tube 4 and the insertion tube 3. When the insertion tube 3 and the casing tube 4 are spliced, the button plate 11 is first pressed to raise the locking column 13 into the first positioning hole 42, then the reducing tube 31 of the insertion tube 3 is inserted into the casing tube 4, then the button plate 11 is released, and then the insertion tube 3 rotates, and in this case, the button plate 11, under the action of the elastic rod 12, causes the locking column 13 to be elastically pressed on the reducing tube 31; and when the first positioning hole 42 is aligned with the second positioning hole 32, the locking column 13 is inserted into the second positioning hole 32 under the action of the elastic rod 12, thereby achieving the locking of the casing tube 4 and the insertion tube 3 and preventing separation between the casing tube 4 and the insertion tube 3. A button body has a simple structure, which achieves both the locking and unlocking of insertion, significantly reduces use of parts, lowers costs, and makes assembly and use thereof simple and convenient.

To facilitate alignment of the first positioning hole 42 with the locking hole 22, a positioning ring 24 is arranged at one end of the locking sleeve 2, the positioning ring 24 is configured to abut against an end portion of the casing tube 4 to ensure that the locking hole 22 is arranged opposite to the first positioning hole 42, and when axes of the first positioning hole 42 and the locking hole 22 are on a same plane, the first positioning hole 42 and the locking hole 22 can be communicated with each other by rotating the casing tube 4.

To directly achieve communication between the first positioning hole 42 and the locking hole 22, a positioning block 25 is arranged inside the locking sleeve 2, and the positioning block 25 is arranged opposite to a positioning groove 41 on the casing tube 4 to ensure that the locking hole 22 is communicated with the first positioning hole 42. The positioning block 25 and the positioning groove 41 cooperate to achieve co-axial arrangement of the first positioning hole 42 and the locking hole 22, which facilitates assembly.

Guide arc corners 411 are arranged at both ends of the positioning groove 41, and the guide arc corners 411 facilitate insertion of the positioning groove 41 into the positioning block 25.

Both the first positioning hole 42 and the second positioning hole 32 are waist-shaped holes, and the waist-shaped holes facilitate movement of the locking column 13 and prevent interference between the locking column 13 and the locking hole 22, which ensures strength of the locking column 13 without need to reduce a diameter of the locking column 13.

To facilitate mounting of the locking button 1, the locking sleeve 2 is provided with a locking groove 21, rotating holes 23 are formed on both sides of the locking groove 21, and the locking hole 22 is formed at a bottom of the locking groove 21; and the rotating shafts 14 are symmetrically arranged on both sides of the locking button 1, and the rotating shafts 14 are rotatably arranged inside the rotating holes 23.

A variable-diameter tube 33 is further arranged between the reducing tube 31 and the insertion tube 3, and the variable-diameter tube 33 abuts against the locking sleeve 2 to ensure that the second positioning hole 32 is arranged opposite to the first positioning hole 42. The variable-diameter tube 33 facilitates processing of the reducing tube 31 and achieves positioning of the reducing tube 31.

The locking button 1 is provided with an elastic pressure groove 16 arranged opposite to the elastic rod 12. The elastic pressure groove 16 is configured to accommodate the elastic rod 12 when the button plate 11 is pressed, which reduces a thickness of the button plate 11, causes a protruding height of the locking button 1 of the connecting rod to be small, and makes an overall structure compact; and further, the elastic pressure groove 16 causes a reinforced edge to be formed around the button plate 11, such that the button plate 11 has enough strength and is not easily deformed when pressed.

To further reduce a length of the button plate 11, one end of the button plate 11 is provided with an avoidance pressure groove 17 that is communicated with the elastic pressure groove 16 and arranged opposite to an end portion of the elastic rod 12. When the button plate 11 is pressed against the elastic rod 12, the end portion of the elastic rod 12 is located inside the avoidance pressure groove 17, without need to increase a length of the button plate 11.

One end of the elastic rod 12 that is in sliding contact with the locking sleeve 2 is provided with a sliding arc surface 121, and the sliding arc surface 121 is capable of effectively reducing friction and ensuring smoother sliding of the elastic rod 12 inside the locking groove 21.

To facilitate the mounting of the rotating shaft 14 on the locking sleeve 2, an insertion inclined surface 141 is arranged on the rotating shaft 14, and the insertion inclined surface 141 causes the rotating shaft 14 to deform toward inside of the button body, which facilitates assembly.

To further facilitate the insertion of the rotating shaft 14 and prevent damage to the rotating shaft 14 during assembly, elastic grooves 15 are formed on both sides of the rotating shaft 14, and the elastic grooves 15 are capable of enhancing the elasticity of the rotating shaft 14 and preventing tearing between the rotating shaft 14 and the button plate 11 during mounting of the rotating shaft 14.

An end portion of the locking column 13 is provided with an insertion arc surface 132, and the insertion arc surface 132 ensures that the locking column 13 is easily inserted into the locking hole 22, with less resistance.

The end portion of the elastic rod 12 can be located on one side of the locking column 13 or at one end of the button plate away from the locking column 13, that is, the locking column 13 and the elastic rod 12 are respectively located at both ends of the button plate.

To facilitate the movement of the locking column 13, the locking hole 22 is arranged to be a waist-shaped hole, and the waist-shaped locking hole 22 facilitates movement of the locking column 13 and prevents interference between the locking column 13 and the locking hole 22, which ensures the strength of the locking column 13 without need to reduce the diameter of the locking column 13.

The locking sleeve 2 facilitates the mounting of the locking button 1 of the connecting rod and enhances the strength of connection between the casing tube 4 and the insertion tube 3. The above functions can be achieved solely through the locking sleeve 2 and the button body, and the present disclosure greatly simplifies the structure, reduces use of parts, lowers costs, and simplifies assembly and operation.

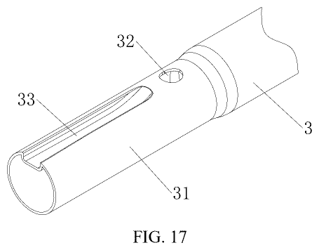

As illustrated in FIG. 17, the reducing tube 31 of the insertion tube 3 is provided with an insertion groove 34, the insertion groove 34 is arranged opposite to the locking column 13, and during the mounting of the insertion tube 3, pressing of the locking button 1 is not required, which facilitates assembly. Further, to further facilitate the insertion of the insertion tube 3 and ensure that the locking column 13 of the locking button 1 is easily lifted, a top portion of the locking column 13 is further provided with a snap-in connection inclined surface 133 arranged opposite to the insertion groove 34, and when the insertion tube 3 is inserted, the snap-in connection inclined surface 133 first abuts against an end portion of the insertion groove 34, and the insertion groove 34 lifts the locking column 13 upward through the snap-in connection inclined surface 133.

Technical principles of the present disclosure are described above with reference to specific examples. These descriptions are only intended to explain the principles of the present disclosure and cannot be interpreted, in any way, as limiting the protection scope of the present disclosure. Based on the explanation, other specific embodiments of the present disclosure can be contemplated by those skilled in the art without making creative efforts, and all these embodiments fall within the protection scope of the present disclosure.

What is claimed is:

1. A connecting rod splicing device, comprising:
a casing tube, wherein one end of the casing tube is provided with a first positioning hole;
an insertion tube, wherein one end of the insertion tube is provided with a reducing tube and a second positioning hole on the reducing tube, the reducing tube is inserted into one end of the casing tube, and the first positioning hole is communicated with the second positioning hole;
a locking sleeve, wherein the locking sleeve is sleeved at one end of the casing tube, and is provided with a locking hole arranged opposite to the first positioning hole; and
a locking button, wherein the locking button is rotatably arranged on the locking sleeve and provided with a button plate and a locking column that is arranged on the button plate and movably inserted into the locking hole, the first positioning hole and the second positioning hole; and an elastic rod configured to keep the locking column in an inserted state, wherein an elastic angle is formed between the elastic rod and the button plate, and the elastic angle enables that the locking column is pulled out of the first positioning hole and the second positioning hole when the locking button is pressed.

2. The connecting rod splicing device according to claim 1, wherein a positioning ring is arranged at one end of the locking sleeve, and the positioning ring is configured to abut against an end portion of the casing tube to ensure that the locking hole is arranged opposite to the first positioning hole.

3. The connecting rod splicing device according to claim 2, wherein a positioning block is arranged inside the locking sleeve, and the positioning block is arranged opposite to a positioning groove on the casing tube to ensure that the locking hole is communicated with the first positioning hole.

4. The connecting rod splicing device according to claim 1, wherein the reducing tube is provided with an insertion groove arranged opposite to the locking column.

5. The connecting rod splicing device according to claim 1, wherein both the first positioning hole and the second positioning hole are waist-shaped holes.

6. The connecting rod splicing device according to claim 1, wherein the locking sleeve is provided with a locking groove, rotating holes are formed on both sides of the locking groove, and the locking hole is formed at a bottom of the locking groove; and the rotating shafts are symmetrically arranged on both sides of the locking button, and the rotating shafts are rotatably arranged inside the rotating holes.

7. The connecting rod splicing device according to claim 1, wherein a variable-diameter tube is further arranged between the reducing tube and the insertion tube, and the variable-diameter tube abuts against the locking sleeve to ensure that the second positioning hole is arranged opposite to the first positioning hole.

8. The connecting rod splicing device according to claim 1, wherein the locking button is provided with an elastic pressure groove arranged opposite to the elastic rod.

9. The connecting rod splicing device according to claim 1, wherein one end of the elastic rod that is in sliding contact with the locking sleeve is provided with a sliding arc surface.

10. The connecting rod splicing device according to claim 1, wherein an end portion of the locking column is provided with an insertion arc surface or a snap-in connection inclined surface.
